(19) United States
(12) Patent Application Publication
(10) Pub. No.: US 2004/0169588 A1
(43) Pub. Date: Sep. 2, 2004

(54) Electronic apparatus

(75) Inventors: Shigeharu Imamura, Ome-shi (JP); Nobuyuki Hosoya, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/761,431

(22) Filed: Jan. 22, 2004

(30) Foreign Application Priority Data
Jan. 22, 2003 (JP) 2003-013853

(51) Int. Cl. G08B 21/00

(52) U.S. Cl. 340/644

(57) ABSTRACT

An electronic apparatus comprises a main body operable in a first state and a second state, a power switch which is disposed in the main body and at least a part of which is made of a light transmissive member, a light emission unit disposed in the main body to emit a light of a first color or a second color through the light transmissive member, and a control unit for controlling the light emission unit to emit a light of the first color when an operation state of the main body is the first state, and to emit a light of the second color when the operation state of the main body is the second state.

### CROSS-REFERENCE TO RELATED APPLICATIONS

This application is based upon and claims the benefit of priority from the prior Japanese Patent Application No. 2003-013853, filed Jan. 22, 2003, the entire contents of which are incorporated herein by reference.

### BACKGROUND OF THE INVENTION

1. Field of the Invention

The present invention relates to an electronic apparatus such as a notebook type personal computer.

2. Description of the Related Art

Among conventional electronic devices such as a notebook type personal computer (hereinafter referred to as the notebook PC), there is an electronic device which comprises a light emitting diode (LED) lit up/out in accordance with a power supply state set by turning on/off of a power switch. When the power switch of the computer is depressed to turn on power, the LED is lit up by, e.g., a green color. When a power supply of the computer is cut off, the LED is lit out. Contents of a technology regarding the lighting up/out of the LED disposed in the electronic device in accordance with power application of the electronic device are described in, for example, Jpn. Pat. Appln. KOKAI Publication No. 2000-306449.

However, the aforementioned LED is lit up/out in accordance with the depressing of the power switch, and it indicates only two kinds of states, i.e., power application and cutting-off states. Thus, for example, it cannot indicate a standby state for power saving such as a standby state (suspended state) specific to the notebook PC. Such an LED is separate from the power switch, and disposed in a place different from a place of the power switch in a notebook PC main body. In this case, after checking on a power supply state of the notebook PC based on a lit-up state of the LED, the place of the power switch must be searched to turn on power. Accordingly, it is required that the power switch is preferably disposed in a place to be easily recognized by a user.

### BRIEF SUMMARY OF THE INVENTION

According to an embodiment of the present invention, an electronic apparatus comprises a main body operable in a first state and a second state, a power switch which is disposed in the main body and at least a part of which is made of a light transmissive member, a light emission unit disposed in the main body to emit a light of a first color or a second color through the light transmissive member, and a control unit for controlling the light emission unit to emit a light of the first color when an operation state of the main body is the first state, and to emit a light of the second color when the operation state of the main body is the second state.

According to an embodiment of the present invention, an electronic apparatus comprises a main body, a display unit rotatably connected to the main body between a first position which is covered with an upper surface of the main body and a second position in which the upper surface of the main body is exposed, a light emission unit which is disposed in the main body and emits a light based on an operation state of the main body, and a detection unit which detects whether the display unit is located at the first position or the second position, wherein the light emission unit is controlled not to emit the light when the detection unit detects that the display unit is located at the first position.

According to an embodiment of the present invention, an electronic apparatus comprises a main body, a display unit rotatably connected to the main body between a first position which is covered with an upper surface of the main body and a second position in which the upper surface of the main body is exposed, a light emission unit which is disposed in the main body and emits a light based on an operation state of the main body, a detection unit which detects whether the display unit is located at the first position or the second position, and a count unit which counts a lapse of time after the detection unit detects that the display unit is located at the second position, the electronic apparatus controlling the light emission unit not to emit the light when the count unit counts a lapse of a predetermined time.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an appearance view of the notebook PC according to one embodiment of the present invention;

FIG. 2 is a sectional view of the power switch 11 of the main body case 1 of the notebook PC shown in FIG. 1 and its periphery;

FIG. 3 is a block diagram showing internal circuitry of the notebook PC shown in FIG. 1;

FIG. 4 is a flowchart showing contents of the first LED lighting-up process executed by the notebook PC shown in FIG. 1;

FIG. 5 is a flowchart showing contents of the second LED lighting-up process executed by the notebook PC shown in FIG. 1.;

FIG. 6 is a flowchart showing contents of the opening/closing associated function of the LED lighting-up process of the notebook PC shown in FIG. 1; and

FIG. 7 is a flowchart showing contents of the timer count function of the notebook PC shown in FIG. 1.

### DETAILED DESCRIPTION OF THE INVENTION

Next, description will be made of an embodiment when the present invention is applied to a notebook type personal computer (hereinafter referred to as the notebook PC) with reference to the accompanying drawings.

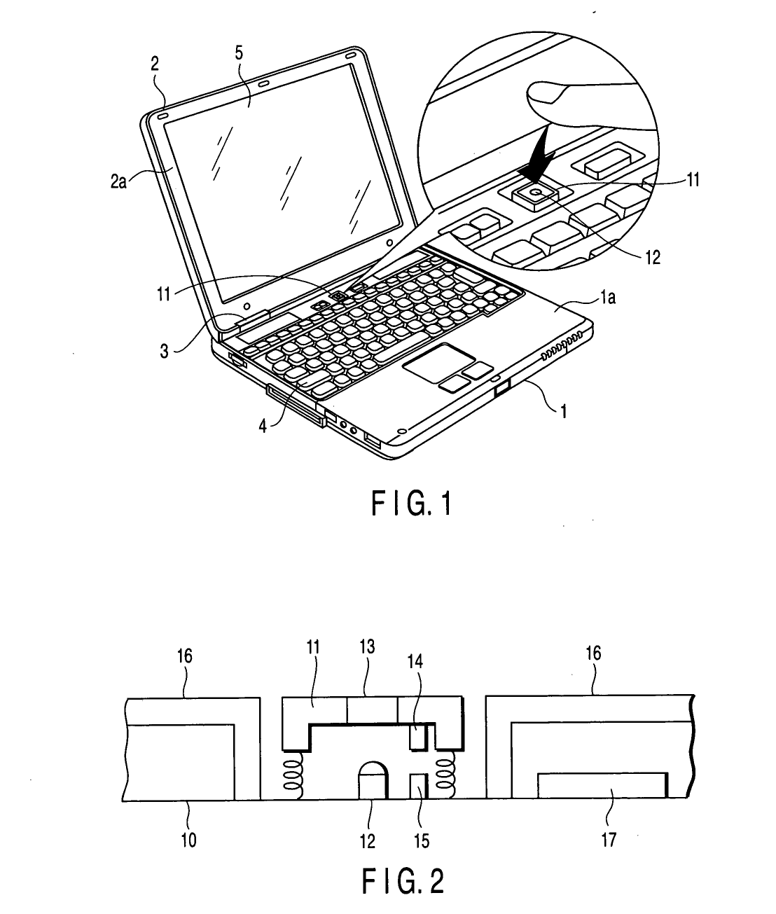

FIG. 1 is an appearance view of the notebook PC according to one embodiment of the present invention.

As shown in FIG. 1, the notebook PC according to the embodiment of the invention has a main body case 1, a display unit case 2, and a hinge unit 3. The hinge unit 3 connects the main body 1 and the display unit case 2 to each other. The hinge unit 3 supports the display unit case 2 rotatably around a rotary shaft (not shown) between a closed state and an opened state. The closed state is a state in which the display unit case 2 covers a keyboard 4. The opened state is a state in which the keyboard 4 is exposed to be used by a user.

The keyboard 4 for an input operation by the user is disposed on an upper surface 1a of the main body case 1. However, on the upper surface 1a, a space is set between the keyboard 4 and the hinge unit 3. On the upper surface 1a, a power switch 11 is disposed in the space between the keyboard 4 and the hinge unit 3. The power switch 11 is made of a semi-transparent member. The display unit case 2 supports a peripheral part of a liquid crystal display (LCD) 5 which is a display device visibly in the opened state. Accordingly, the LCD 5 is disposed so that its display surface can be visible. A light emitting diode (LED) 12 is disposed in a position opposite an upper surface of the power switch 11 in the main body case 1. According to the embodiment, the LED 12 can emit lights of three colors, and emits a light of a blue, orange or yellow color, or a light in which all these colors are mixed in accordance with a system state of the notebook PC, i.e., a power supply state. As the power switch 11 is made of the semi-transparent member (or a transparent member), the LED 12 emits a light to be radiated through the power switch 11. According to the embodiment, the power switch 11 is disposed in the space set on an upper side of the keyboard 4, i.e., in the space between the keyboard 4 and the hinge unit 3, on the upper surface 1a of the main body case 1. A position in which the power switch 11 is disposed is not normally touched by hand when the user operates the keyboard 4. Additionally, the position of the power switch 11 is a position in which a sight line movement from the LCD 5 is small and which comes within user's field of vision when the user uses the notebook PC. Thus, by disposing the power switch 11 on the upper surface 1a, if the display unit case 2 is in the opened state, the user can easily recognize a system state of the notebook PC based on an emitted light color of the power switch 11 (LED 12). However, the place in which the power switch 11 is disposed is not limited to the upper surface 1a of the main body case 1. For example, it is permissible to dispose the power switch 11 on a front face 2a of the display unit case 2. The place in which the LED 12 is disposed is not limited to the position opposite the upper surface of the power switch 11. Any other places are permitted as long as they enable transmission of a light emitted from the LED 12 through the surface of the power switch 11.

The notebook PC of the embodiment has a function of changing a color of a light emitted from the LED 12 in accordance with a power supply state of the notebook PC. The power supply state means, for example, a state in which power of the notebook PC has been turned on (hereinafter referred to as the starting state), a state in which an operation of the notebook PC has been temporarily stopped (hereinafter referred to as the suspended state), or a state in which an operating system (OS) has been finished to stop the operation of the notebook PC (hereinafter referred to as the shutdown state).

According to the embodiment, the LED 12 is lit up to be blue in the starting state of the notebook PC, lit up to be yellow in the suspended state, and lit up to be orange in the shutdown state. A light emitted from the LED 12 is transmitted through the power switch 11 made of the semi-transparent member to enable the user to easily understand the system state of the notebook PC, and to easily recognize the place in which the power switch 11 is disposed. There is no particular limitation on a color of a light emitted from the LED 12.

FIG. 2 is a sectional view of the power switch 11 of the main body case 1 of the notebook PC shown in FIG. 1 and its periphery.

As shown in FIG. 2, the power switch 11, the LED 12, a power switch depressing detection unit 15, a case cover 16, and an embedded controller (hereinafter referred to as the EC) 17 are disposed on the substrate 10. The power switch 11 is pressed from the inside to the outside of the main body case 1 by an elastic member. The power switch 11 is disposed to be positioned substantially on the same plane as that of the upper surface 1a of the main body case 1 in a state in which the power switch 11 is not depressed by the user. When the power switch 11 is depressed to be moved apart, it returns to the position to be substantially on the same plane as that of the upper surface 1a of the main body case 1 by the elastic member. According to the embodiment, the power switch 11 is attached to the substrate 10 through, e.g., a spring.

A switch terminal 14 is disposed below the power switch 11. The switch terminal 14 is brought into contact with the power switch depressing detection unit 15 in accordance with depressing of the power switch 11. When it is brought into contact with the switch terminal 14, the power switch depressing detection unit 15 sends a driving control signal to the EC 17.

Upon reception of the driving control signal from the power switch depressing detection unit 15, the EC 17 determines a system state of the notebook PC to control a color of a light emitted from the LED 12.

A transmission cover 13 made of a semi-transparent member is disposed on a center of the power switch 11. This transmission cover 13 is a semi-transparent or transparent member made of, e.g., plastic, glass or the like. The transmission cover 13 can transmit a light emitted from the LED 12 upward. If the transmission cover 13 is seen from the user in a state in which the LED 12 emits a light, it is visually recognized as if the light is emitted from the power switch 11. According to the embodiment, the center of the power switch 11 is constituted of the transmission cover 13. However, only a peripheral end of the power switch 11 may be constituted of a transmission member, and an entire surface of the power switch 11 may be constituted of the transmission cover 13.

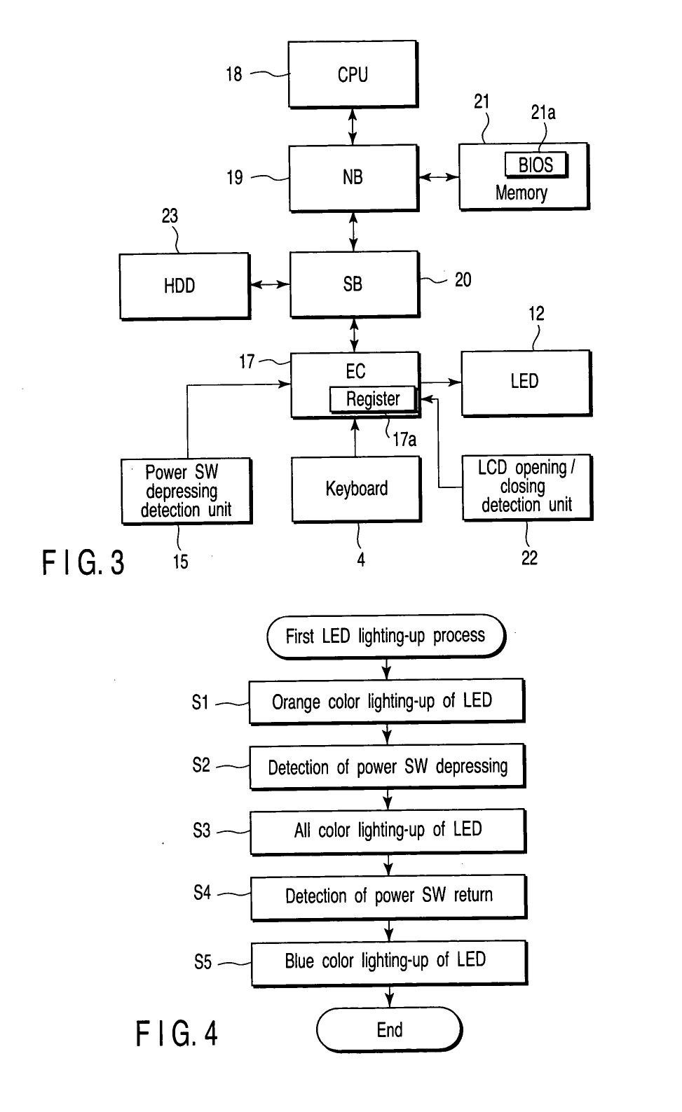

FIG. 3 is a block diagram showing internal circuitry of the notebook PC shown in FIG. 1.

In FIG. 3, there is shown a constitution only of a portion related to the present invention in the internal circuitry of the notebook PC. As shown in FIG. 3, a CPU 18 is disposed to be in charge of the entire notebook PC. A north bridge (NB) 19 is connected to the CPU 18, and a south bridge (SB) 20 is connected to the NB. A main memory 21 which becomes a work area when the CPU 18 is operated is connected to the NB 19. A BIOS 21a is stored in the main memory 21. The BIOS 21a is a program for controlling an input/output device during a system operation of the notebook PC, and a basic output/input of the notebook PC. At the time of starting the notebook PC, the BIOS 21a is read from a BIOS-ROM (not shown) to be copied in the main memory 21. After the start of the notebook PC, basic input/output control and management of a power supply state are mainly carried out based on the BIOS 21a copied in the main memory 21.

A hard disk drive (HDD) 23 is connected to the SB 20. The HDD 23 is a nonvolatile storage medium, and a device capable of storing data even in a state in which power is not on for the notebook PC. The HDD 23 stores an OS and application program and, when such program is executed, it is properly evolved in the main memory 21. The NB 19 is, for example, a bridge circuit for executing processing such as data and address conversion between itself and the device CPU 18 connected to the NB 19. The SB 20 is a bridge circuit for executing processing such as a data input/output between devices connected interconnected through the SB 20. The EC 17 is connected to a bus extended from the SB 20. The EC 17 has a register 17a. Reading/writing can be carried out in the register 17a by control from the CPU 18. The power switch depressing detection unit 15, the keyboard 4, the LED 12, and an LCD opening/closing detection unit 22 are connected to the EC 17. The LCD opening/closing detection unit 22 is disposed, for example, on the upper surface 1a of the main body case 1 shown in FIG. 1. The LCD opening/closing detection unit 22 is a projected member disposed by being pressed from the inside of the main body case 1 toward the upper surface 1a by the elastic member, and it can be slid up and down in accordance with opening/closing of the display unit case 2. When the display unit case 2 is rotated from the opened state to the closed state, the LCD opening/closing detection unit 22 is depressed by the display unit case 2 to be slid down, and it detects a transition of the display unit case 2 from the opened state to the closed state. When the display unit case 2 is rotated from the closed state to the opened state, the LCD opening/closing detection unit 22 is no longer pressed by the display unit case 2 to be slid up by the elastic member, and it detects a transition of the display unit case 2 from the closed stat to the opened state. As described above, the LCD opening/closing detection unit 22 detects the opened/closed state of the display unit case 2. The register 17a is a rewritable memory. The register 17a especially stores control processing program for a process of lighting-up the LED 12 and deciding a color of a light emitted therefrom when it is lit up (hereinafter referred to as the LED lighting-up process). The register 17a also stores information indicating a system state of the notebook PC for a light emission process of the LED 12. The CPU 18 rewrites stored contents of the register 17a under control of the BIOS 21a in accordance with a state of the notebook PC. Control processing program for the LED lighting-up process may be prestored in a ROM (not shown) in the EC 17.

Next, description will be made of a process of the notebook PC for LED light emission according to the embodiment.

First, description will be made of an LED lighting-up process (referred to as a first LED lighting-up process) when a system state of the notebook PC is switched from a shutdown state to a starting state.

FIG. 4 is a flowchart showing contents of the first LED lighting-up process executed by the notebook PC shown in FIG. 1.

It is assumed that the notebook PC is in a shutdown state. In this state, the LED 12 is lit up by an orange color (step S1), and a light of an orange color is emitted from the power switch 11. Then, when the user depresses the power switch 11, the switch terminal 14 is brought into contact with the power switch depressing detection unit 15. The power switch depressing detection unit 15 detects the depressing of the power switch 11 when it is itself brought into contact with the switch terminal 14 (step S2). The power switch depressing detection unit 15 outputs a driving control signal to the EC 17. This driving control signal contains information indicating the depressing of the power switch 11. Upon entry of the driving control signal from the power switch depressing detection unit 15, the EC 17 controls the LED 12 to be lit up by all colors of blue, orange and yellow (step S3). By emission of the three-color light from the LED 12, a light close to white is seen to be emitted from the LED 12 by the user.

Then, when the user releases the power switch 11 depressed as mentioned above, the switch terminal 14 is moved apart from the power switch depressing detection unit 15. After the separation of the switch terminal 14 from the power switch depressing detection unit 15, the power switch depressing detection unit 15 detects this separation (S4). Then, the power switch depressing detection unit 15 outputs a driving control signal to the EC 17. This driving control signal contains information indicating a return of the power switch 11 to the position before it is depressed by the user. Upon entry of the driving control signal from the power switch depressing detection unit 15, the EC 17 determines that the system state of the notebook PC has been switched to a starting state. Then, the EC 17 rewrites the control information stored in the register 17a to information indicating the starting state under control of the BIOS 21a. The EC 17 controls the LED 12 to emit a light of a blue color in accordance with the control information stored in the register 17a (step S5).

In consequence, the user can easily recognize the switching of the system state of the notebook PC from the shutdown state to the starting state based on the color of the light emitted from the LED 12 incorporated in the power switch 11. Moreover, since the power switch 11 made of the semi-transparent member is disposed on the upper surface 1a of the main body case 1, and the LED 12 is disposed below the power switch 11, the power supply state of the notebook PC can be recognized without changing a point of view.

In the aforementioned example, when the power switch 11 is depressed or separated by the user, the driving control signal indicating the depressing/nondepressing of the power switch 11 is outputted from the power switch depressing detection unit 15. However, this driving control signal may be represented by a binary signal of, e.g., “1”, “0”. For example, the power switch depressing detection unit 15 can detect the depressing of the power switch 11 at the EC 17 by outputting a signal of “1” (predetermined voltage level) when the power switch 11 is depressed, and a signal of “0” (voltage level is zero) when the power switch 11 is not depressed.

Next, description will be made of an LED lighting-up process (hereinafter referred to as the second LED lighting-up process) when the system state of the notebook PC is switched from the starting state to the suspended or shutdown state.

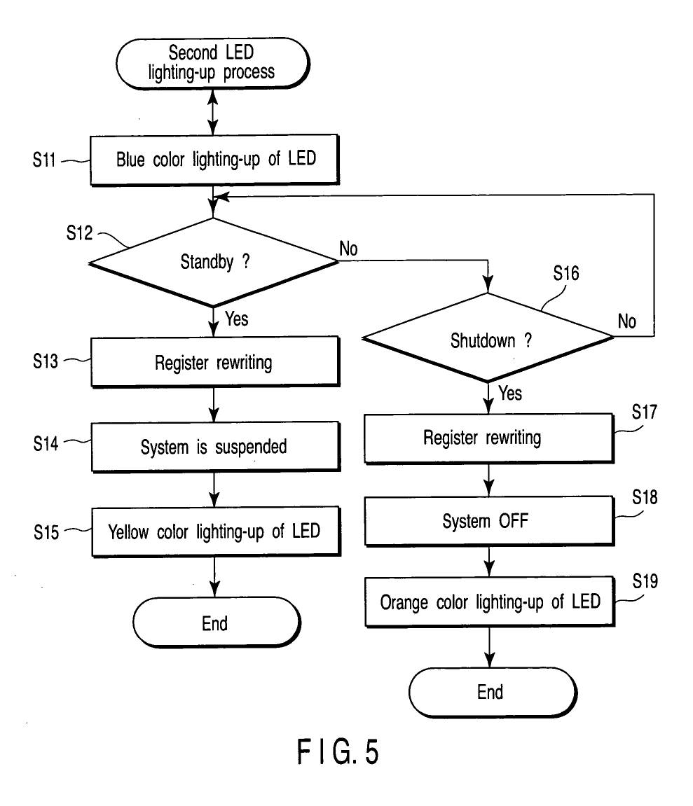

FIG. 5 is a flowchart showing contents of the second LED lighting-up process executed by the notebook PC shown in FIG. 1.

It is assumed that the system state of the notebook PC is a starting state. In this state, the LED 12 is lit up by a blue color (step S11). For example, in accordance with an OS menu screen displayed on the LCD 5, a command for switching the system state of the notebook PC to the suspended state (hereinafter referred to as the standby command), or a command for switching the system state of the notebook PC to the shutdown state (hereinafter referred to as the shutdown command) is entered by the keyboard 4.

If the standby command is entered on the OS menu screen (YES in step S12), the CPU 18 rewrites the control information stored in the register 17a of the EC 17 to information indicating the suspended state under control of the BIOS 21a (step S13). After the transfer of the system state of the notebook PC to the suspended state (step S14), the EC 17 controls the LED 12 to be lit up by a yellow color in accordance with the control information stored in the register 17a (step S15).

On the other hand, if the shutdown command is entered on the OS menu screen (from NO of step S12 to YES of step S16), the CPU 18 rewrites the control information stored in the register 17a to information indicating the shutdown state under control of the BIOS 21a (step S17). After setting of the system state of the notebook PC to a shutdown state (step S18), the EC 17 controls the LED 12 to be lit by an orange color in accordance with the control information stored in the register 17a (step S19).

Accordingly, the user can easily understand each of the states when the system state of the notebook PC is switched from the starting state to the suspended data or the shutdown state by the command entry on the OS menu screen.

The notebook PC of the embodiment has a control function of executing or stopping the first LED lighting-up process by the depressing of the power switch 11 or the second LED lighting-up process by the command entry in accordance with an opened/closed state of the display unit case 2 (hereinafter referred to as the opening/closing associated function of the LED lighting-up process).

The opening/closing associated function executes the first LED lighting-up process and the second LED lighting-up process when the notebook PC is in an opened state, and stops the lighting of the LED 12 when the notebook PC is in a closed state. In the closed stat of the notebook PC, since the power switch 11 is covered with the display unit case 2, the user cannot understand a lit-up state of the LED 12. That is, in the closed state, the lighting-up of the LED 12 causes wasteful consumption of a battery of the notebook PC, and unnecessary deterioration of characteristics of the LED 12 and the other components. The opening/closing associated function is mounted to solve the above problems. The opening/closing associated function is realized by storing a control program for the opening/closing associated function in, e.g., the EC 17, and executing the control program.

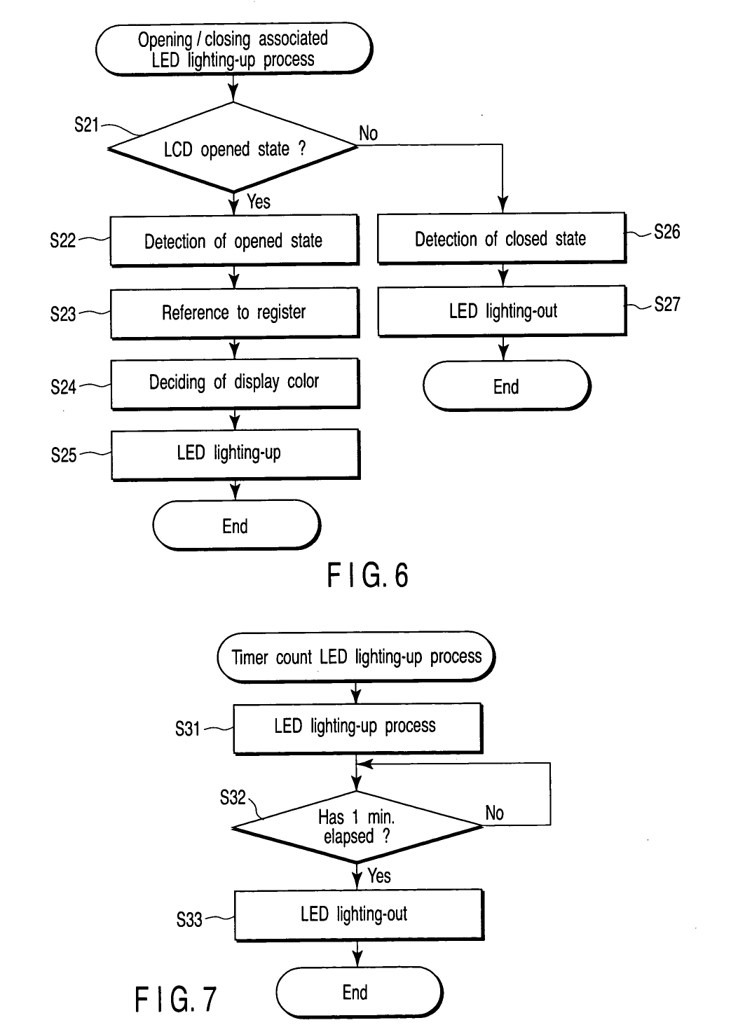

FIG. 6 is a flowchart showing contents of the opening/closing associated function of the LED lighting-up process of the notebook PC shown in FIG. 1.

First, the LCD opening/closing detection unit 22 detects which of the closed state and the opened state the notebook PC is in. When it detects that the notebook PC is in the opened state, the LCD opening/closing detection unit 22 outputs a driving control signal to the EC 17 (steps S21 to S22). Upon entry of the driving control signal from the LCD opening/closing detection unit 22 in the opened state, the EC 17 refers to the control information written in the register 17a to recognize the system state of the notebook PC (step S23). As described above, the system state is one of a starting state and a suspended or shutdown state. A display color of the LED 12 corresponding to each state is as described previously. Then, a light of a decided display color is emitted from the LED 12 (step S25).

On the other hand, when it detects a transfer of the opened/closed state of the display unit case 2 from the opened state to the closed state, the LCD opening/closing detection unit 22 outputs a driving control signal to the EC 17 (steps S21 to S26). Upon entry of the driving control signal from the LCD opening/closing detection unit 22 in the closed state, the EC 17 controls the LED 12 to be lit out irrespective of a power supply state (step S27).

As described above, the use of the opening/closing associated function of the LED lighting-up process enables prevention of wasteful consumption of the battery of the notebook PC, and unnecessary deterioration of the characteristics of the LED 12 and the other components.

Next, description will be made of a timer count function which the notebook PC of the embodiment has.

The timer count function executes the first LED lighting-up process and the second LED lighting-up process, and lights out the LED 12 when a predetermined time elapses after the LED 12 is lit up by a blue, yellow or orange color.

The user can easily recognize a current system state of the notebook PC by watching the power switch 11 (LED 12) lit-up by a blue, yellow or orange color. However, if the user stores the recognized system state, the LED 12 needs not be constantly lit. By lighting out the LED 12, it is possible to prevent wasteful consumption of batter power. The timer count function is realized by storing a timer count control program in, e.g., the EC 17, and executing this program.

FIG. 7 is a flowchart showing contents of the timer count function of the notebook PC shown in FIG. 1.

First, in the first LED lighting-up process and the second LED lighting-up process, when a color of a light emitted from the LED 12 is switched to another color, or the LED 12 is changed from a lit-out state to a state for emitting a light of a specific color, timer counting is started (steps S31, S32). After a lapse of a predetermined time (e.g., 1 min. according to the embodiment) from the start of the timer counting, the EC 17 controls the LED 12 to be lit out irrespective of a color of a light emitted from the LED 12 (steps S32 to S33).

In the aforementioned example, irrespective of the system state (lit color of the LED 12) of the notebook PC, the LED 12 is lit out after the lapse of the predetermined time from the change of the system state. However, for example, the LED 12 may be constantly lit in a starting state, and the LED 12 may be lit out after the lapse of the predetermined time in the suspended or shutdown state.

For example, if the notebook PC is driven by a battery, irrespective of the system state (lit color of the LED 12) of the notebook PC, the LED 12 may be controlled to be lit out after the lapse of the predetermined time from the change of the system state. If the notebook PC is driven by a commercial power source such as an AC adaptor, the LED 12 may be controlled to be constantly lit only in a specific system state (starting state of the notebook PC in the above example). If the state is changed to the other state, the LED 12 may be controlled to be lit out after the lapse of the predetermined time. In this case, a power supply origin is determined by a power supply microcomputer (not shown), and a control signal based on a result of the determination is sent to the EC 17. The EC 17 controls the LED 12 to be lit up or out based on the control signal from the power supply microcomputer.

As described above, as in the case of the opening/closing associated function, the use of the timer count function enables prevention of wasteful consumption of the battery of the notebook PC, and unnecessary deterioration of the characteristics of the LED 12 and the other components.

The notebook PC of the embodiment can functionally select presence of execution of the function of the first LED lighting-up process, the function of the second LED lighting-up process, the opening/closing associated function of the first, second LED lighting-up processes, and the timer count function. A process for this selection is realized by, for example, storing software which has a function of selecting presence of execution of various functions in the HDD 23, starting the software to display a selection screen for the presence of execution of various functions on the LCD 5, and entering a command for selecting the presence of execution by the user through the keyboard 4 in accordance with the selection screen.

Next, description will be made of an operation when the opening/closing associated function and the timer count function are both used according to the embodiment. When the notebook PC is switched from the opened state to the closed state, the first and second LED lighting-up processes are stopped by the opening/closing associated function. When the notebook PC is switched from the closed state to the opened state, the first and second LED lighting-up processes are executed by the opening/closing associated function, and the LED 12 is lit out after 1-minute timer counting by the timer count function.

Thus, according to the embodiment, since the color of the light emitted from the LED 12 is changed in accordance with the change of the power supply state of the notebook PC, the user can easily understand the system state of the notebook PC, and easily recognize the place of the power switch 11.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An electronic apparatus comprising:
a main body operable in a first state and a second state;
a power switch which is disposed in the main body and at least a part of which is made of a light transmissive member;
a light emission unit disposed in the main body to emit a light of a first color or a second color through the light transmissive member; and
a control unit for controlling the light emission unit to emit a light of the first color when an operation state of the main body is the first state, and to emit a light of the second color when the operation state of the main body is the second state.

2. The electronic apparatus according to claim 1,
wherein the power switch is disposed on an upper surface of the main body.

3. The electronic apparatus according to claim 1, further comprising:
a display unit rotatably connected to the main body between a first position which is covered with the keyboard and a second position in which the keyboard is exposed; and
a detection unit which detects whether the display unit is located at the first position or the second position,
wherein the control unit controls the light emission unit not to emit the light when the detection unit detects that the display unit is located at the first position.

4. The electronic apparatus according to claim 3, further comprising:
a count unit which counts a lapse of time after the detection unit detects that the display unit is located at the second position,
wherein the control unit controls the light emission unit not to emit the light when the count unit counts a lapse of a predetermined time.

5. The electronic apparatus according to claim 1,
wherein a keyboard is disposed in a part of the upper surface of the main body; and the power switch is disposed in the space set on an upper side of the keyboard on the upper surface of the main body.

6. The electronic apparatus according to claim 5, further comprising:
a display unit rotatably connected to the main body between a first position which is covered with the keyboard and a second position in which the keyboard is exposed; and
a detection unit which detects whether the display unit is located at the first position or the second position,
wherein the control unit controls the light emission unit not to emit the light when the detection unit detects that the display unit is located at the first position.

7. The electronic apparatus according to claim 6, further comprising:
a count unit which counts a lapse of time after the detection unit detects that the display unit is located at the second position,
wherein the control unit controls the light emission unit not to emit the light when the count unit counts a lapse of a predetermined time.

8. The electronic apparatus according to claim 1,
wherein the first state is a starting state of the main body; and the second state is a shutdown state of the main body.

9. The electronic apparatus according to claim 8,
wherein the main body is further operated in a third state which is a suspended state; the light emission unit further emits a light of a third color; and the control unit controls the light emission unit to emit a light of the third color when an operation state of the main body is the third state.

10. The electronic apparatus according to claim 9, further comprising:
a display unit rotatably connected to the main body between a first position which is covered with the keyboard and a second position in which the keyboard is exposed; and
a detection unit which detects whether the display unit is located at the first position or the second position,
wherein the control unit controls the light emission unit not to emit the light when the detection unit detects that the display unit is located at the first position.

11. The electronic apparatus according to claim 10, further comprising:
a count unit which counts a lapse of time after the detection unit detects that the display unit is located at the second position,
wherein the control unit controls the light emission unit not to emit the light when the count unit counts a lapse of a predetermined time.

12. An electronic apparatus comprising:
a main body;
a display unit rotatably connected to the main body between a first position which is covered with an upper surface of the main body and a second position in which the upper surface of the main body is exposed;
a light emission unit which is disposed in the main body and emits a light based on an operation state of the main body; and
a detection unit which detects whether the display unit is located at the first position or the second position,
wherein the light emission unit is controlled not to emit the light when the detection unit detects that the display unit is located at the first position.

13. An electronic apparatus comprising:
a main body;
a display unit rotatably connected to the main body between a first position which is covered with an upper surface of the main body and a second position in which the upper surface of the main body is exposed;
a light emission unit which is disposed in the main body and emits a light based on an operation state of the main body;
a detection unit which detects whether the display unit is located at the first position or the second position; and
a count unit which counts a lapse of time after the detection unit detects that the display unit is located at the second position;
the electronic apparatus controlling the light emission unit not to emit the light when the count unit counts a lapse of a predetermined time.
